(19) United States
(12) Patent Application Publication
(10) Pub. No.: US 2012/0050757 A1
(43) Pub. Date: Mar. 1, 2012

(54) Color Substitution Mechanism

(76) Inventors: David Wagner, Broomfield, CO (US); Larry M. Ernst, Longmont, CO (US); Jo S. Kirkenaer, Lyons, CO (US)

(21) Appl. No.: 12/871,610

(22) Filed: Aug. 30, 2010

(51) Int. Cl. G06F 15/00

(52) U.S. Cl. 358/1.9

(57) ABSTRACT

A computer generated method disclosed. The method includes examining a print job file to retrieve a source color to be mapped from a source color space to a device color space, receiving a starting color, generating a set of color patches based on the starting color and selecting a first patch in the set of color patches as a replacement color.

### FIELD OF THE INVENTION

The invention relates to the field of printing systems. Particularly, the invention relates to substituting colors in a printing system.

### BACKGROUND

Growth in color management has resulted in an increase in software packages that are used to generate International Color Consortium (ICC) profiles. ICC profiles describe color attributes of a particular device or viewing requirement by defining a mapping between a source or target color space and a Profile Connection Space (PCS), such as either CIELAB (L*a*b*) or CIEXYZ.

However, print customers often request that one or more colors specified in a print job accurately match desired colors. While some colors in a print job are not needed, or may be reproduced within some tolerance range, other colors are essential and require accurate color reproduction. For example, a customer may request a set of colors printed with an old printer of a different vendor be accurately matched by a new color printer. An acceptable match to such colors may not be available at the printer at which a job is being performed.

Therefore, mechanism to accurately match colors is desired.

### SUMMARY

In one embodiment a computer generated method is disclosed. The method includes examining a print job file to retrieve a source color to be mapped from a source color space to a device color space, receiving a starting color, generating a set of color patches based on the starting color and selecting a first patch in the set of color patches as a replacement color.

In another embodiment, a print server is disclosed. The print server includes a printing software product having a color mapping tool to examine a print job file and generate a replacement color by mapping a source color in the print job file to a corresponding device color for a printer.

In yet a further embodiment a computer system is disclosed, including a memory to store a printing software product, a processor, coupled to the memory, to execute the printing software product and a display device to display a graphical user interface (GUI) upon the processor executing the printing software product. The GUI includes menu options to enable color mapping between a source color in a print job file to a corresponding device color for a printer

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a screen shot of one embodiment of a color mapping tool GUI;

FIG. 3 is a flow diagram illustrating one embodiment of performing color mapping;

FIGS. 4A and 4B illustrate one embodiment of visual representations of a color mapping process;

FIG. 5 illustrates one embodiment of a printed patch page; and

FIG. 6 illustrates one embodiment of a computer system.

### DETAILED DESCRIPTION

A color substitution mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

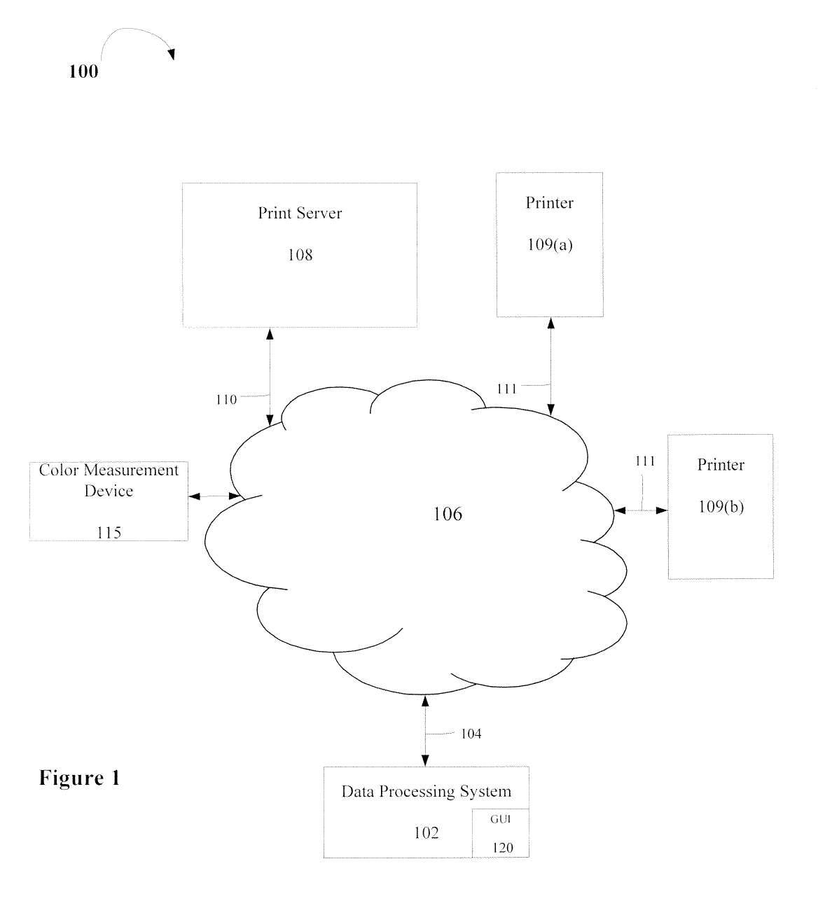

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, a print application at data processing system 102 allows a user to select the desired print server 108 and submit requests for service requests to printer 109 via print server 108 over network 106. In a further embodiment, the print application implements the (Advanced Function Presentation) AFP™ presentation system developed by International Business Machines Corporation to represent documents in a data format that is independent of the methods that are utilized to capture or create those documents.

According to the AFP system, documents may include combinations of text, image, graphics, and/or barcode objects in device and resolution independent formats. Documents may also include and/or reference fonts, overlays, and other resource objects, which are required at presentation time to present the data properly. In other embodiments, additional/alternative presentation architectures may be implemented at the print application.

However in an AFP embodiment, the print application provides a Mixed Object Document Content Architecture (MO:DCA) data stream to print server 108. In such an embodiment, the AFP MO:DCA data streams are object-oriented streams including, among other things, data objects, page objects, and resource objects. Although described with reference to AFP data streams, other embodiments may implement, PostScript (PS) and Portable Document Format (PDF) data streams.

Although described as separate entities, other embodiments may include print server 108 being incorporated in one or more of the printers 109. In yet further embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 and one or more of printers 109. In other embodiments, the printing software product manages printing of documents from multiple data processing systems 102 to the one or more printers 109. In one embodiment, the printing software product may be implemented using either InfoPrint Manager (IPM) or InfoPrint ProcessDirector (IPPD), although other types of printing software may be used instead. In a further embodiment, the print application at data processing system 102 interacts with the printing software product to provide for efficient transmission of print jobs.

In one embodiment, the printing software product includes a graphical user interface (GUI) 120 accessible at a data processing system 102 that enables a system administrator (or operator) to interact with the printing software product and print application. In such an embodiment, GUI 120 includes a color adjustment tool (e.g., the InfoPrint Color Adjustment Tool (ICAT)) that allows a user to create a mapping between source colors in an AFP print file and a corresponding device color (e.g., Cyan, Magenta, Yellow, Black (CMYK)) for printers 109, wherein the source colors in the print file are substituted with desired colors on the printer.

In one embodiment, the color adjustment tool performs color mapping based on color measurement data received from a color measurement device 115. Upon completion of the color mapping process color mapping tool generates an ICC printer profile and corresponding text file. According to one embodiment, the color adjustment tool subsequently transmits a color patch print job, along with ICC printer profile and text file, to one or more of printers 109.

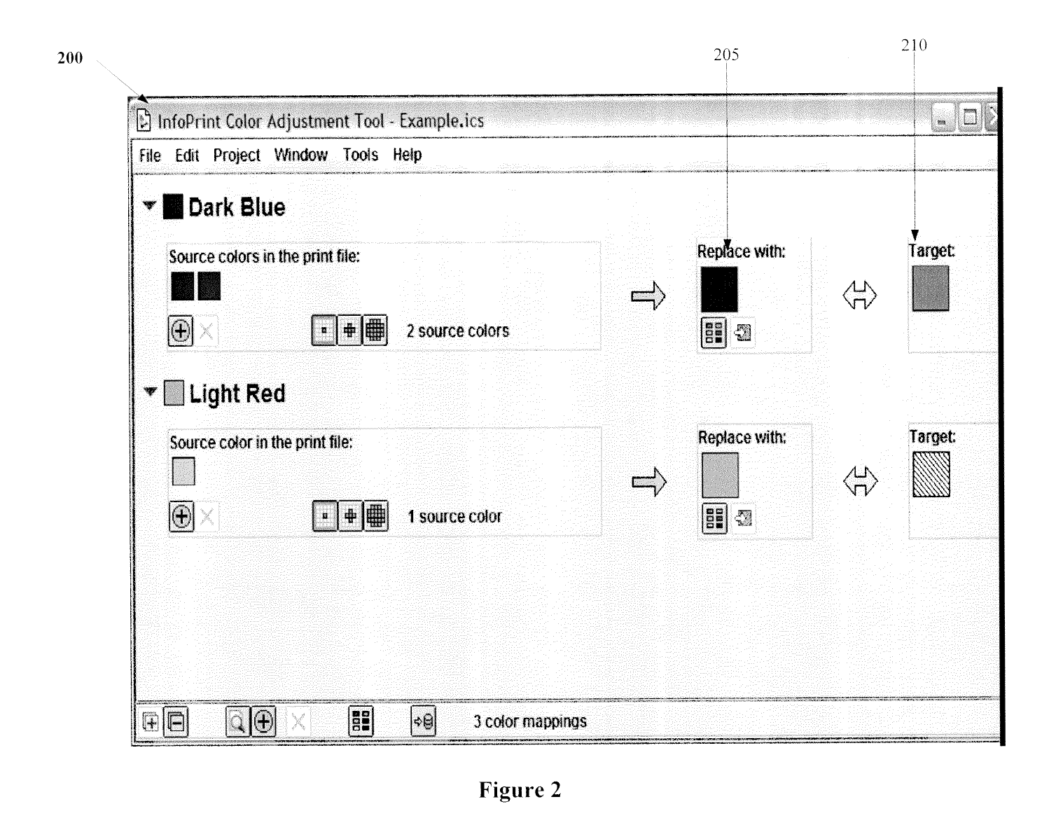

FIG. 2 illustrates one embodiment of GUI 120 including a color mapping tool 200. GUI provides a viewer that enables a user to identify source object color values in a print job. Additionally, the viewer displays pages and a catalog of all images in a print file. After selecting an image, the viewer shows the colors inside of the image.

According to one embodiment, color mapping tool 200 operates with three color categories: source colors; replacement color; and target color. A source color represents one or more colors in a print file (e.g., AFP, PDF or PostScript) that do not print satisfactorily on a targeted printer 109, and thus is to be replaced. The source colors may be in any color space (CMYK, RGB, CIELab, grayscale, OCA or highlight). In one embodiment, OCA and highlight are used only in AFP files.

A replacement color represents device CMYK color for which the source color should be replaced. Since the replacement color is not initially known, the first guess at a replacement color may be based on either of the source colors, or a target color, if specified. In one embodiment, the replacement color result is in the device CMYK color space. However during the iteration process, the replacement color may be stored as LAB.

The target color (or “desired color”) represents a known color that the replacement color should be matched to. In one embodiment, the target color is a L*a*b* color, such as a Pantone color. Also, the entering of a target color may be optional. In one embodiment, color mapping tool 200 informs a user if a printer 109 is capable of printing a color with a small color difference to the target color.

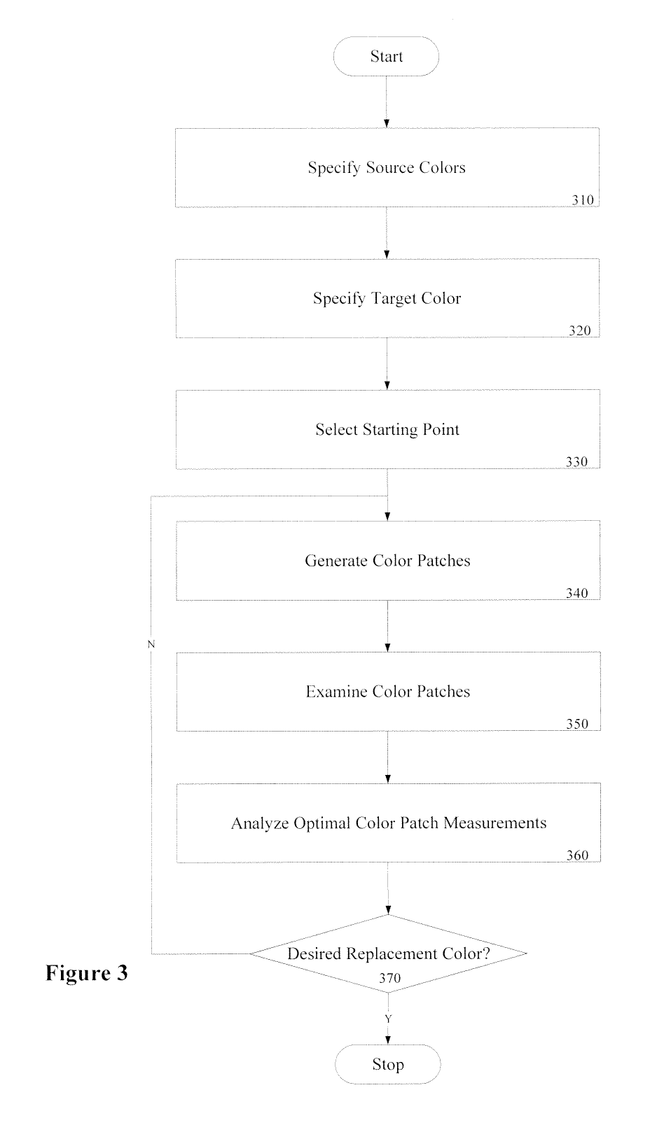

FIG. 3 is a flow diagram illustrating one embodiment of a color mapping process. At processing block 310, the source colors are specified. According to one embodiment, the source colors are automatically specified by color mapping tool 200 performing an examination of a print file. However in other embodiments, a user may implement color mapping tool 200 may select the source colors to find the colors in the file that will not print satisfactorily.

At processing block 320, a target color may be specified in order to provide the color to which the replacement color is to be matched. As discussed above, this process is optional. For instance, if color measurement device 115 is implemented to measure the color patches, the user inputs the target color values. The target color is entered into color mapping tool 200 by clicking on a “Target” icon 210 (FIG. 2) and entering the appropriate values. However if a color measurement device 115 is not used, this process is skipped. Thus, color mapping tool 200 is configured with “Use Spectrophotometer” set to “no”, Target icon 210 is not displayed.

At processing block 330, a starting point is selected. In one embodiment, color mapping tool 200 assumes that the optimal starting point to find a desired color is the color value in the print job. However, in other embodiments the user may provide a superior starting point. For example, the user may be aware from previous applications of an improved starting point in some color space and thus provides the information as the starting point. In such an embodiment, the starting point is entered into color mapping tool 200 by clicking on a “Replace with” icon 205 (FIG. 2) along with the applicable values. Further, a color measurement device (e.g., a spectrophotometer) may be used to measure the target color in L*A*B* color space, where the user provides the information as the starting point.

At processing block 340, a set of color patches is generated by color mapping tool 200. In one embodiment, the set of color patches includes nine pages, each with a grid of 17×17 patches (e.g., 289 patches per page). The nine pages of patches are configured to achieve two objectives: a) desired level of robustness when Human Observer selects the most pleasing color and b) minimize the total number of color print jobs necessary to select the pleasing color.

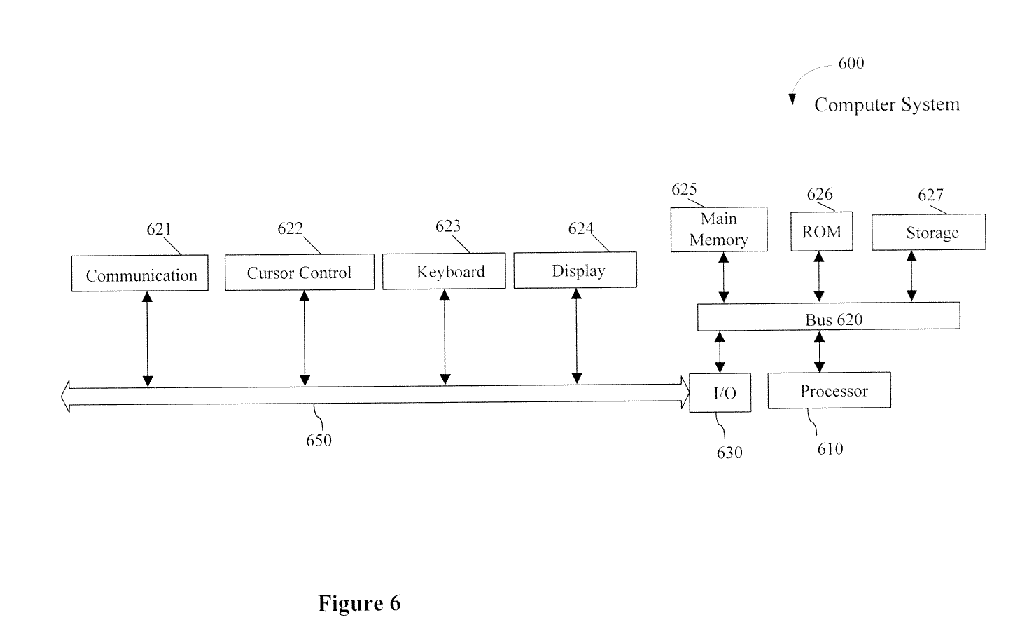

FIG. 6 illustrates one embodiment of a patch page displayed by color mapping tool 200 in a LAB subspace. From the displayed image, a user may determine which of the color patches may be reproduced correctly by the printer. In one embodiment, color patches with a dotted line border cannot be reproduced correctly. An advantage to this embodiment is that it provides the user with insight into why certain colors are not reproduced correctly.

As part of the job definition, several inputs may be required. One input is the user defining a portion of L*A*B* space to scan for the pleasing color. Because the color patches layout is based on L*A*B* space, the color difference between the nearest neighbor patches may be estimated where the objective is to select a default range for a pleasing color when the search is resolved. In one embodiment, color mapping tool 200 recommends a default range setting adequate to find the pleasing color.

For continuous form duplex printer where the paper path is very long (e.g., typically greater than 50 feet), paper usage is extremely high if the printer must start and stop numerous times to resolve the search for a pleasing color. With the optimal number of the printed patches defined in L*A*B* subspace and the default range setting, the number of iteration searches is significantly reduced. For many applications, a single search is possible.

In one embodiment, the processes performed in FIG. 3 may operate in a parallel processing environment for several color searches to be initiated at the same time. For the generation of the color patches in processing block 340, individual color patch print jobs may be concatenated into a single print job in order to reduce paper usage. For any one skilled in the art, reducing the paper usage to find the pleasing color leads to greater printer utilization for printing print jobs for either production (high print volume) cut sheet printers or production (high print volume) continuous forms printers.

As other input the user defines a paper size (e.g., 8.5×11 for US, and A4 for the rest of the world), and the print job file name and location to store the print job. A user may either transfer the print job file to the printer manually or via network 106 for printing. Further, the user requests color mapping tool 200 to generate a color measurement device input template data files if a color measurement device is used to measure the patches. Further, the user may transfer the template data files to the Color Measurement Device manually or via network 106.

At processing block 350, the color patches are examined. The printed patches may be evaluated using a Human Observer (HVS) or color measurement device. If HVS visual observation is used, the following may be performed to determine the pleasing color: using same paper type on which the patches were printed cut a 0.35″ to 0.40″ diameter round or 0.35″ to 0.4″ square hole in the center of a sheet; placing at least five sheets of the same type of paper behind each printed page of patches for backing for viewing on a standard desk or table top; covering all of the patches except for a single patch while viewing using the sheet with the hole cut into it, where the viewing distance for optimal comparison is approximately 5 to 6 inches from each page; viewing each individual patch against the visual target color patch and selecting the best comparison patch from the 9 pages of patches for each target color; and recording the page index, column index, and row index for the optimal patch for each target color.

If a color measurement device is used, a XY table along with the spectrophotometer (or other semi-automatic color measurement devices) is implemented to semi-automatically measure the patches for consistency and accuracy.

At processing block 360, the color measurements of a selected patch are analyzed. In one embodiment, the results are entered into color mapping tool 200 after completing the color measurements. For visual observation, the user inputs the coordinates (or location) of the optimal patch from the print job. In one embodiment, the input is three data points: 1) patch page index, 2) page row index, and 3) page column index. Color mapping tool 200 subsequently automatically calculates the color values for the optimal patch.

For color measurement device implementations, the user inputs the output files from the measurement equipment manually or receives the files via network 106 that captured the measurement results. Upon receiving the input file, color mapping tool 200 automatically calculates the color difference relative to the target color to find the optimal color patch (e.g., patch with smallest color difference). In one embodiment, AE76 is used to calculate the color difference. As discussed above, color mapping tool 200 automatically calculates the color values for the optimal patch.

At decision block 370 it is determined whether the optimal patch color values represent a desired replacement color. For typical applications, the achieved results are satisfactory after processing block 360 is sufficient. If so, the process is completed. However, if the desired results were not achieved, control is returned to processing block 340 where the process is completed by printing a new set of patches.

In one embodiment, color mapping tool 200 assumes that if the user selects a “print a set of patches” option an additional iteration (or repeat of the process to improve results) is requested. In such an embodiment, color mapping tool 200 changes the center color to the previously selected best color for the new set of patches, and automatically reduces the “range” by one-half over the L*A*B* color space in each dimension. Once a desired result is achieved, or the range value is reduced to a minimum value, the iteration cycles are terminated.

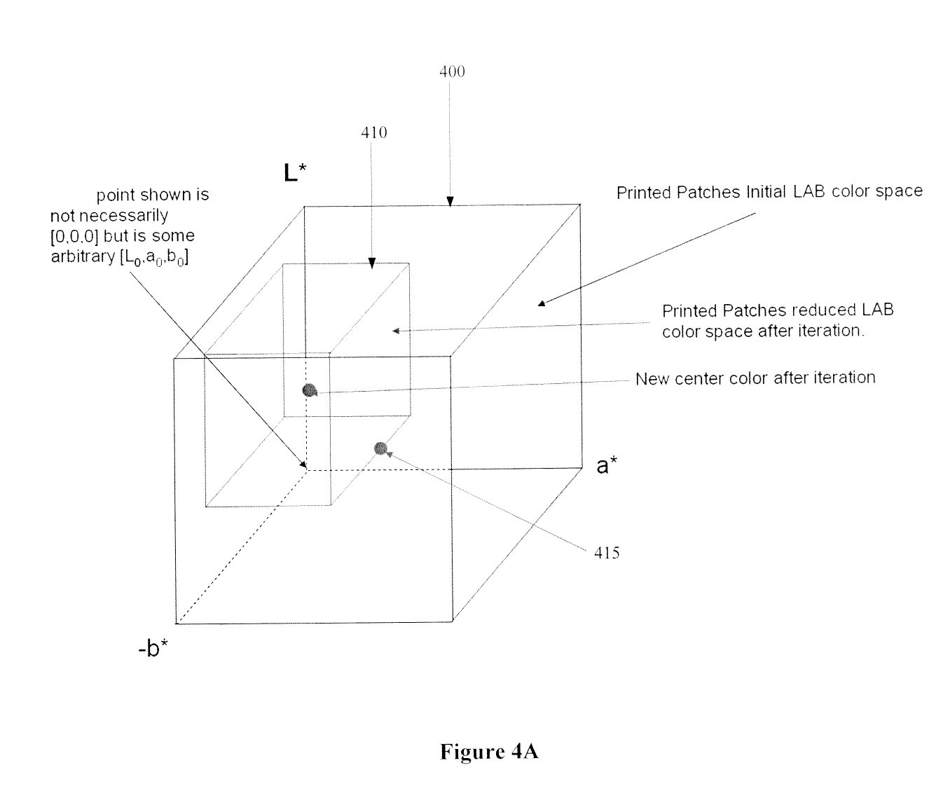

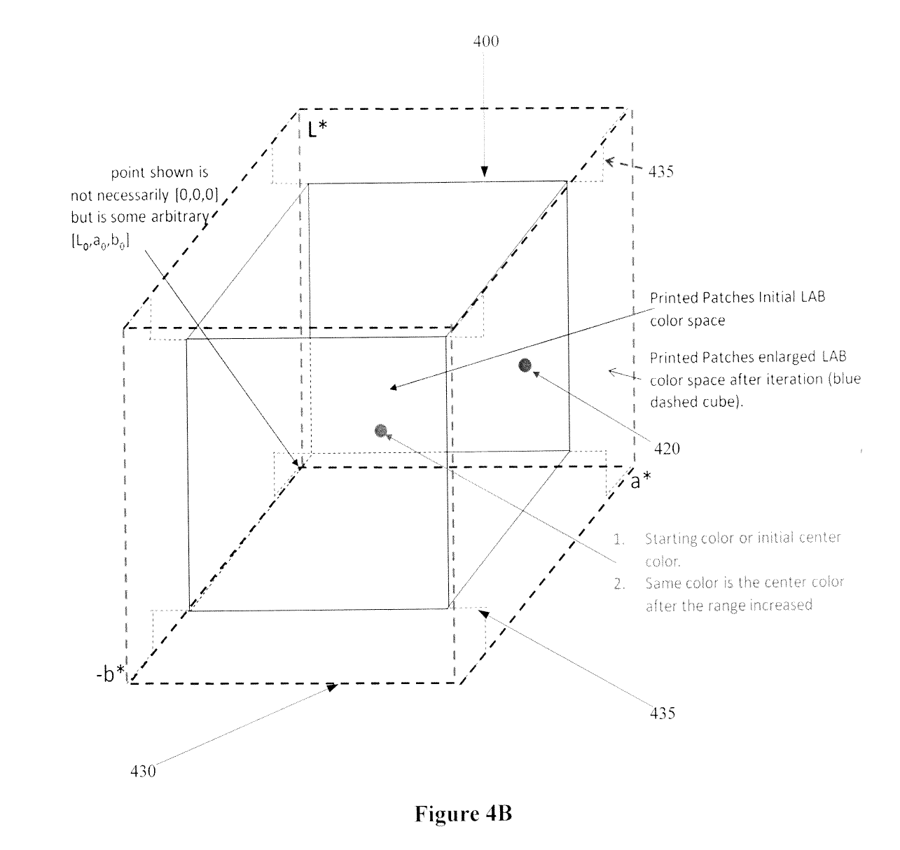

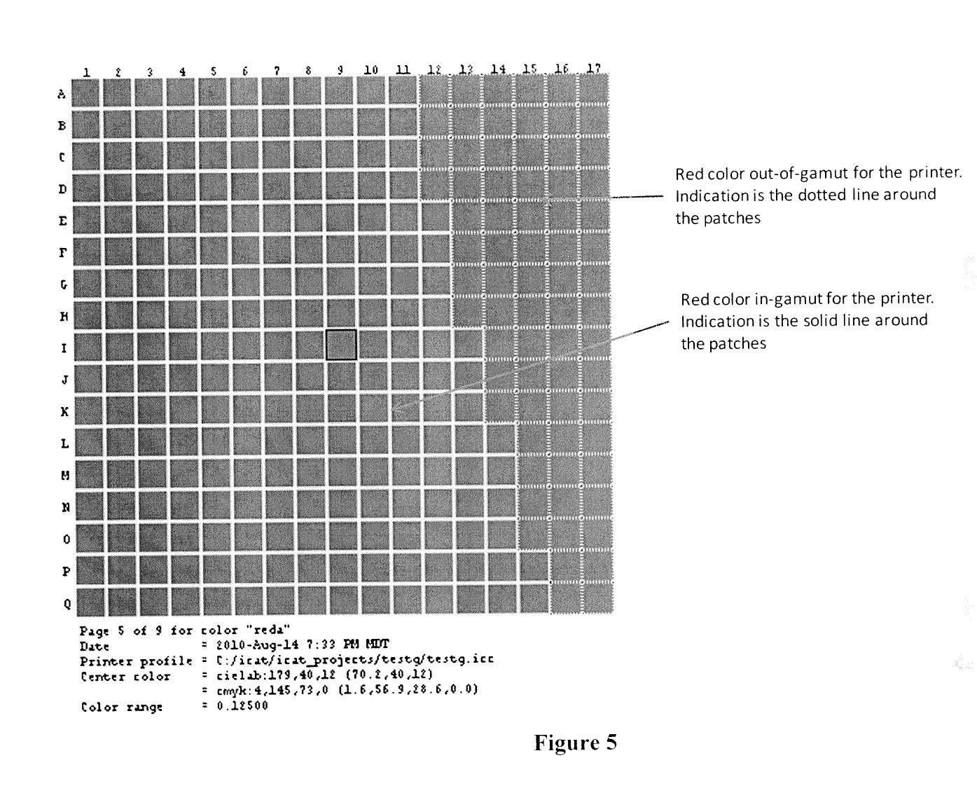

FIG. 4A illustrates one embodiment of a best color representation following processing blocks 310-360 based on the L*A*B* subspace. If HVS visual observation is used to evaluate the print sample for a pleasing color relative to the target color, the user informs color mapping tool 200 if a second search is necessary. If color measurement device 115 is used and if the color difference minimum result is too large, the color mapping tool 115 asks the user if a second search is necessary.

Assuming the results are unsatisfactory, a second search is performed where the subspace is reduced by a factor of two in each dimension as shown by the L*A*B* subspace 410. Point 415 is the starting point for the second iteration and corresponds to the optimal color found from the first iteration. A new best color representation is found from the second search.

In one embodiment, color mapping tool 200 informs the user if a search with a larger range for any improvements by performing an additional iteration. For instance, if the coordinates from either the visual observation or color measurements is on the boundary of the L*A*B* subspace, color mapping tool 200 warns the user that a larger “range” setting should have been used. Thus, it may be necessary to repeat the process with a larger range setting, unless the visual results are satisfactory or the color difference is small enough.

FIG. 4B illustrates one embodiment of best color representation LAB subspace 400 showing the redefinition of the LAB search space. As shown in FIG. 4B, point 420, representing the color selected in after the initial iteration, is on the cube boundary. Thus, the process is repeated with a larger range setting to produce LAB subspace 430. Points 435 shows how the LAB cube volume increases when the range is increased.

Once the color mapping process has been completed, the results are saved in the form of a ICC printer profile and text file (e.g., to a folder, external drive, or transferred to the printer manually or via network 106) so the color substitution of the pleasing colors are performed during printing of the job.

FIG. 6 illustrates a computer system 600 on which data processing system 102 and/or server 108 may be implemented. Computer system 600 includes a system bus 520 for communicating information, and a processor 610 coupled to bus 520 for processing information. Computer system 600 further comprises a random access memory (RAM) or other dynamic storage device 625 (referred to herein as main memory), coupled to bus 620 for storing information and instructions to be executed by processor 610.

Main memory 625 also may be used for storing temporary variables or other intermediate information during execution of instructions by processor 610. Computer system 600 also may include a read only memory (ROM) and or other static storage device 626 coupled to bus 620 for storing static information and instructions used by processor 610. A data storage device 625 such as a magnetic disk or optical disc and its corresponding drive may also be coupled to computer system 500 for storing information and instructions.

Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A computer generated method comprising:
examining a print job file to retrieve a source color to be mapped from a source color space to a device color space;
selecting a starting color;
generating a set of color patches based on the starting color; and
selecting a first patch in the set of color patches as a replacement color.

2. The method of claim 1 wherein selecting the first patch comprises:
examining the set of color patches to determine an optimal color patch; and
analyzing one or more values of the optimal color patch.

3. The method of claim 2 wherein the set of color patches is examined using a visual observation process.

4. The method of claim 2 wherein analyzing the one or more values comprises:
receiving coordinates for the optimal color patch; and
calculating the one or more color values based on the coordinates.

5. The method of claim 4 wherein the coordinates comprise at least one of a patch page index, a page row index and a page column index.

6. The method of claim 2 wherein the set of color patches is examined using a color measurement device.

7. The method of claim 6 wherein analyzing the one or more values comprises:
examining an output file received from the color measurement device; and
calculating a color difference relative to a target color to determine the optimal color patch; and
calculating the one or more color values based on the relative color difference.

8. The method of claim 7 further comprising providing feedback if a minimum color difference of the set of color patches relative to the target color exceeds a threshold.

9. The method of claim 1 further comprising receiving a target color representative of the replacement color.

10. The method of claim 1 wherein selecting the starting color comprises selecting the source color in the print job file.

11. The method of claim 1 wherein selecting the starting color comprises receiving a user selected starting point.

12. The method of claim 1 further comprising determining if the replacement color is sufficient to replace the source color.

13. The method of claim 12 further comprising:
selecting the first replacement color as a second starting color if the replacement color is not sufficient;
generating a second set of color patches based on the second starting color; and
selecting a first patch in the second set of color patches as the replacement color.

14. The method of claim 13 wherein a search direction is determined independent of user input.

15. The method of claim 1 further comprising:
determining if coordinates of the first color patch is on a boundary of a color space; and
providing an indication that a larger color range should be used.

16. The method of claim 15 wherein a search direction is determined independent of user input.

17. A print server comprising a printing software product having a color mapping tool to examine a print job file and generate a replacement color by mapping a source color in the print job file to a corresponding device color for a printer.

18. The print server of claim 17 wherein the source color is replaced by the replacement color at the printer.

19. The print server of claim 17 wherein the color mapping tool comprises a viewer to enable identification of source object color values in the print job file.

20. The print server of claim 19 wherein the viewer displays a catalog of images in the print job file.

21. The print server of claim 20 wherein the viewer includes a page preview to enable a user to preview and select from a page of images.

22. The print server of claim 20 wherein the viewer displays colors associated with a selected image.

23. The print server of claim 17 wherein the color mapping tool examines the print job file to retrieve a source color to be mapped from a source color space to a device color space, selects a starting color, generates a set of color patches based on the starting color and selects a first patch in the set of color patches as a replacement color.

24. The print server of claim 20 wherein the color mapping tool further determines if the replacement color is sufficient to replace the source color.

25. The print server of claim 24 wherein the color mapping tool further selects the first replacement color as a second starting color if the replacement color is not sufficient, generates a second set of color patches based on the second starting color and selects a first patch in the second set of color patches as the replacement color.

26. The print server of claim 17 wherein multiple searches are operated to concatenate search print jobs into a single print job.

27. An article of manufacture comprising a machine-readable medium including data that, when accessed by a machine, cause the machine to perform operations comprising:
examining a print job file to retrieve a source color to be mapped from a source color space to a device color space;
receiving a starting color;
generating a set of color patches based on the starting color; and
selecting a first patch in the set of color patches as a replacement color.

28. The article of manufacture of claim 27 wherein selecting the first patch comprises:
examining the set of color patches to determine an optimal color patch; and
analyzing one or more values of the optimal color patch.

29. The article of manufacture of claim 28 wherein analyzing the one or more values comprises:
receiving coordinates for the optimal color patch; and
calculating the one or more color values based on the coordinates.

30. The method of claim 28 wherein the set of color patches is examined using a color measurement device.

31. The article of manufacture of claim 30 wherein analyzing the one or more values comprises:
examining an output file received from the color measurement device; and
calculating a color difference relative to a target color to determine the optimal color patch; and
calculating the one or more color values based on the relative color difference.

32. The article of manufacture of claim 27 further comprising receiving a target color representative of the replacement color.

33. The article of manufacture of claim 27 when accessed by the machine, further cause the machine to perform operations comprising determining if the replacement color is sufficient to replace the source color.

34. The article of manufacture of claim 33 when accessed by the machine, further cause the machine to perform operations comprising:
selecting the first replacement color as a second starting color if the replacement color is not sufficient;
generating a second set of color patches based on the second starting color; and
selecting a first patch in the second set of color patches as the replacement color.

35. A computer system comprising:
a memory to store a printing software product;
a processor, coupled to the memory, to execute the printing software product; and
a display device to display a graphical user interface (GUI) upon the processor executing the printing software product, the GUI having menu options to enable color mapping between a source color in a print job file to a corresponding device color for a printer.
